(19) United States
(12) Patent Application Publication
(10) Pub. No.: US 2015/0149054 A1
(43) Pub. Date: May 28, 2015

(54) AUTOMATIC DIFFERENTIAL CONTROL SYSTEM WITH MANUAL OVERRIDE MODE

(71) Applicant: Caterpillar Inc., Peoria, IL (US)

(72) Inventors: Michael C. Gentle, MAROA, IL (US); Dustin Funk, DUNLAP, IL (US); Kevin M. Moloney, WASHINGTON, IL (US); Brad R. Van de Veer, WASHINGTON, IL (US)

(73) Assignee: Caterpillar Inc., Peoria, IL (US)

(21) Appl. No.: 14/609,448

(22) Filed: Jan. 30, 2015

(51) Int. Cl. F16H 48/22

(52) U.S. Cl. CPC F16H 48/22; F16H 2048/204
USPC 701/67

(57) ABSTRACT

A method of controlling a differential assembly of a machine is disclosed herein. The differential assembly may be locked by use of a differential lock. The differential lock is adapted to operate in at least one of an automatic mode and a manual override mode. The differential lock is activated and/or deactivated by an automatic differential control system with a manual override mode. The method initiates with activation of the automatic differential control system. Thereafter, the automatic differential control system may be overridden by activation of the manual override mode, while the automatic differential control system continues to be activated. Thereafter, the manual override mode may be deactivated by use of the automatic differential control system based on one or more of a plurality of operational parameters.

### TECHNICAL FIELD

The present disclosure relates generally to control of a differential lock of a machine. More specifically, the present disclosure relates to control of the differential lock with use of an automatic differential control system.

### BACKGROUND

Various machines, such as motor graders, are commonly known to include a differential assembly that assists in the turning of a machine. The differential assembly is required to be locked and unlocked based on operational conditions of the machine. For example, the differential assembly may be locked during operation of the machine on a straight path. Also, the differential assembly may be unlocked while the machine turns on a curved path. Therefore, the machine is equipped with a differential lock that selectively locks and unlocks the differential assembly while the machine is in operation. The differential lock is adapted to operate in an automatic mode using an automatic differential control system.

The automatic differential control system automatically activates and deactivates the differential lock based on a plurality of operational parameters (steering angle, engine torque and/or transmission gear range). The automatic differential control system is known to have a time delay and may fail to operate soon enough in specific operating conditions of the machine. In such situations, the mode switch may be changed to disable automatic control in order to allow operator (manual) control of differential lock engagement and disengagement through a control switch. The control switch is tasked to manually lock and unlock the differential assembly. The control switch has a relatively lower response time and is therefore efficient in allowing operator control due to forward looking ability of the machine operating conditions.

In conventional known systems, the control switch becomes inactive when the automatic differential control system is activated. Therefore, the differential assembly may be left unlocked until the automatic differential control system determines the need for differential lock to be activated. This may cause inappropriate control unacceptable delay of the differential lock activation. Additionally, if a manually activated control switch fails to disengage the differential lock at the appropriate time, it may induce undue stresses on various component of the machine such as the differential, chains, and other drivetrain components.

U.S. Pat. No. 4,570,509 discloses a locking differential control system that controls the locking and unlocking of a differential gear mechanism (differential assembly) of a machine. The differential control system includes one set of operator controlled devices to lock the differential gear mechanism and another set of operator controlled devices to unlock the differential gear mechanism. Although, this reference discloses controlled locking and unlocking of the differential gear mechanism, it may also fail if the operator forgets to lock or unlock the differential gear mechanism at the appropriate time for the conditions the machine is being operated in.

### SUMMARY OF THE INVENTION

Various aspects of the present disclosure are directed to a method of controlling a differential assembly of a machine. The machine includes an automatic differential control system. The differential assembly includes at least one differential lock that selectively locks the differential assembly. The at least one differential lock is adapted to operate in at least one of an automatic mode and a manual override mode. The method initiates with activation of the automatic differential control system that selectively locks the differential assembly. Thereafter, the automatic differential control system is overridden by activation of the manual override mode, thereby the differential assembly is locked manually, while the automatic differential control system is kept activated. Based on one or more of the plurality of operational parameters, the manual override mode is deactivated by use of the automatic differential control system. Thereby, the differential assembly is unlocked.

### BRIEF DESCRIPTION OF THE DRAWINGS

FIG. 1 is a perspective view of a machine that illustrates various components of the machine, in accordance with the concepts of the present disclosure;

FIG. 2 is a block diagram of the automatic differential control system that works in conjunction with a differential lock and a differential assembly, in accordance with the concepts of the present disclosure;

FIG. 3 is a perspective view of an interior of an operator cabin of the machine of FIG. 1, that illustrates position of various controls of the machine, in accordance with the concepts of the present disclosure;

FIG. 4 is an enlarged view of the interior of the operator cabin of FIG. 3, that illustrates a control panel, in accordance with the concepts of the present disclosure; and

FIG. 5 is a flowchart of the method to controllably lock and unlock of the differential assembly of FIG. 2, in accordance with the concepts of the present disclosure.

### DETAILED DESCRIPTION

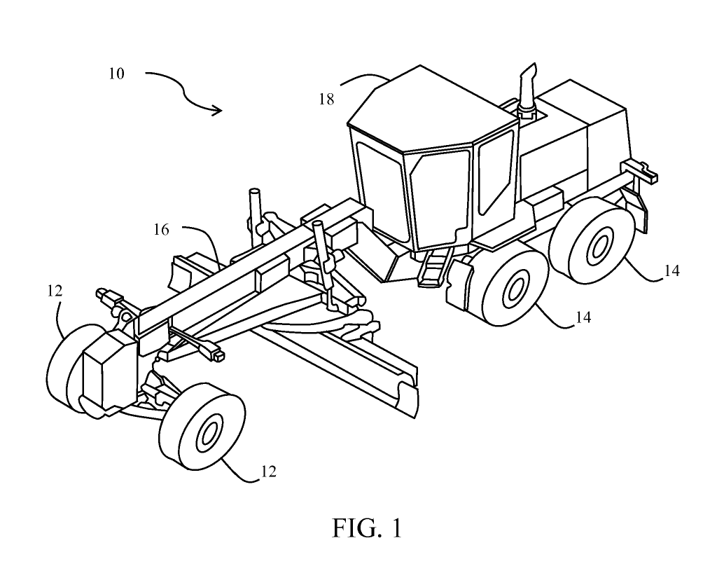

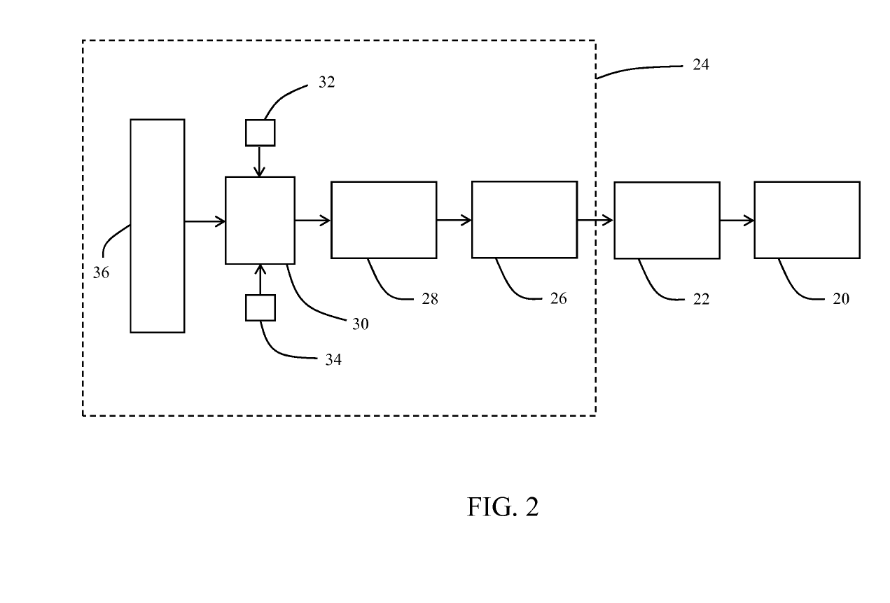

Referring to FIG. 1, there is shown a perspective view of a machine 10. The machine 10 may embody a construction machine, a forest machine, and/or any other similar machine. Although, a motor grader is shown as a preferred embodiment in the current disclosure, it may be noted that the concepts of the present disclosure should not be limited to the motor grader. The machine 10 includes a set of front wheels 12, a set of rear wheels 14, a blade 16, and an operator cabin 18. The blade 16 is generally positioned between the front wheels 12 and the rear wheels 14, and is adapted to level ground surface during roads construction. The operator cabin 18 is a region where a multiplicity of controls of the machine 10 may be installed and are accessible to an operator positioned within the operator cabin 18. Furthermore, the machine 10 includes a number of systems that controls various functionalities associated with the machine 10. One such system is a differential assembly 20 that facilitates turning of the machine 10, during normal machine operation. For controlled and efficient operation, the differential assembly 20 works in conjunction with a differential lock 22 and an automatic differential control system 24, which are best described in FIG. 2.

Referring to FIG. 2, there is shown the differential assembly 20 that works in conjunction with the differential lock 22 and the automatic differential control system 24, for controlled and efficient operation. The differential assembly 20 may be an assembly of differential gears (not shown) operably connected to the rear wheels 14 of the machine 10. As is customarily known, the differential assembly 20 may require to be locked and unlocked based on operating conditions of the machine 10. More specifically, the differential assembly 20 may require to be locked while the machine 10 travels on a straight path and may require to be unlocked while the machine 10 takes a turn. Notably, locking and unlocking of the differential assembly 20 are accomplished with use of the differential lock 22.

The differential lock 22 may be an electrically actuated clutch assembly operatively connected to the differential assembly 20. The differential lock 22 may be activated and/or deactivated to lock and unlock the differential assembly 20. More specifically, the differential lock 22 may couple with the differential assembly 20 to lock it, when activated. Conversely, the differential lock 22 may decouple with the differential assembly 20 to unlock it, when deactivated. Notably, the differential lock 22 is activated and/or deactivated with use of the automatic differential control system 24. Moreover, the differential lock 22 is adapted to operate in at least one of an automatic mode and a manual override mode. Notably, the automatic mode of operation refers to full automatic control of the differential lock 22. However, the manual override mode refers to manual control of the differential lock 22, while still having the automatic mode in operation. In the automatic mode of operation, the differential lock 22 is automatically activated and/or deactivated with use of the automatic differential control system 24.

The automatic differential control system 24 is operatively connected to the differential lock 22 and is adapted to activate and/or deactivate the differential lock 22 of the machine 10. When actuated, the automatic differential control system 24 automatically activates and/or deactivates the differential lock 22 based on operational parameters of the machine 10. The operational parameters of the machine 10 may include a steering angle, an engine torque, a transmission gear table, and/or the like. More particularly, the automatic differential control system 24 may activate the differential lock 22 when the operational parameters are within predefined limits Conversely, the automatic differential control system 24 may deactivate the differential lock 22 as the operational parameters breach the predefined limits The automatic differential control system 24 includes a lock solenoid 26, a lock relay 28, a controller 30, a mode switch 32, a control switch 34, and a power supply 36

The lock solenoid 26 of the automatic differential control system 24 is operatively connected to the differential lock 22, and is adapted to activate and/or deactivate the differential lock 22. Energizing and/or de-energizing the lock solenoid 26 corresponds to activation and/or deactivation of the differential lock 22 of the machine 10, respectively.

In an embodiment, the lock relay 28 is operatively connected to the lock solenoid 26 and is adapted to energize and/or de-energize the lock solenoid 26. Energizing and/or de-energizing the lock relay 28 corresponds to energizing and/or de-energizing the lock solenoid 26. Therefore, it may be envisioned that energizing and/or de-energizing the lock relay 28 corresponds to activation and/or deactivation of the differential lock 22. Although, the present disclosure contemplates the use of both of the lock solenoid 26 and the lock relay 28 for activation and/or deactivation of the differential lock 22, it may be noted that the differential lock 22 may be activated and/or deactivated with use of the lock solenoid 26, individually.

The controller 30 may be a control unit electrically connected to the lock relay 28 and continuously powered by the power supply 36. The controller 30 is adapted to automatically energize and/or de-energize the lock relay 28 for automatic activation and/or deactivation of the differential lock 22. The controller 30 may be operatively connected to a number of operational parameter sensors that sense the operational parameters of the machine 10. The controller 30 may automatically energize the lock relay 28, when the operational parameters are within predetermined limits Conversely, the controller 30 may automatically de-energize the lock relay 28, as the operational parameters breach the predefined limits for a predetermined time. In an exemplary embodiment, the controller 30 may energize the lock relay 28 when the steering angle is below a lower steering threshold limit and the engine torque is above an upper torque threshold limit while the gear range is in a desired range. Also, the controller 30 may de-energize the lock relay 28 when the steering angle is above an upper steering threshold limit, or the engine torque is below a lower threshold limit, or the gear range is changed to an undesired range.

The mode switch 32 is connected to the controller 30 of the automatic differential control system 24 and is adapted to activate and/or deactivate the controller 30. It may be envisioned that activation and/or deactivation of the controller 30 corresponds to activation and/or deactivation of the automatic differential control system 24. More specifically, the mode switch 32 activates the controller 30 and correspondingly the automatic differential control system 24, when the mode switch 32 is set to an automatic mode position. Moreover, the mode switch 32 deactivates the controller 30 and correspondingly the automatic differential control system 24, when the mode switch 32 is set to an operator control position.

The control switch 34 may function as a manual override input for the automatic differential control system 24 and is connected to the controller 30 of the automatic differential control system 24. The control switch 34 is adapted to manually override the automatic differential control system 24 and operate the differential lock 22 in the manual override mode. More specifically, as the control switch 34 is triggered, the lock relay 28 is energized to activate the differential lock 22. This facilitates overriding of the automatic differential control system 24. Notably, overriding the automatic differential control system 24 corresponds to manual activation of the differential lock 22. Therefore, as the control switch 34 is triggered, the automatic differential control system 24 is overridden and the differential lock 22 is actuated to manually lock the differential assembly 20. Notably, in the present embodiment, the controller 30 is still active, when the automatic differential control system 24 is overridden. Therefore, the controller 30 is operative throughout the operation of the automatic differential control system 24.

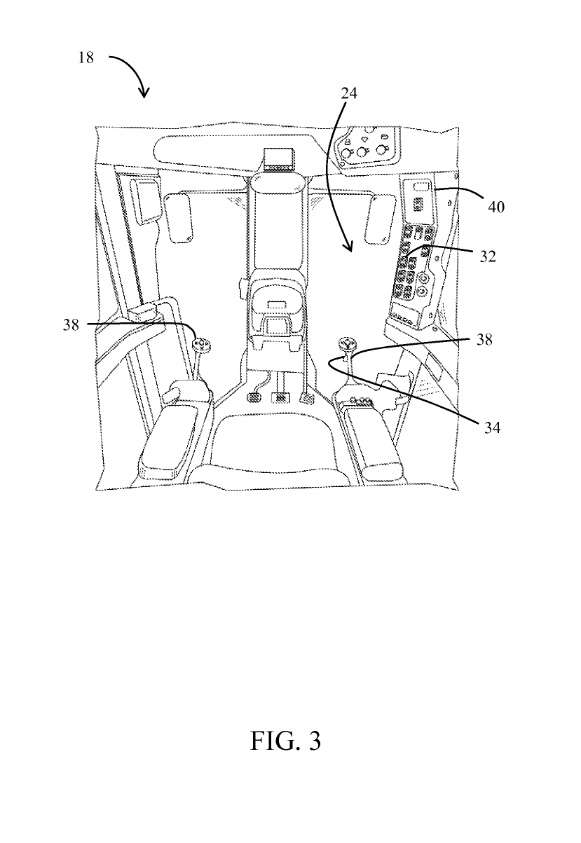

Referring to FIG. 3, there is shown an interior of the operator cabin 18 of the machine 10 that illustrates the position of the mode switch 32 and the control switch 34 relative to the machine 10. The interior of the operator cabin 18 includes a number of controls that may be accessed by an operator to control various functions of the machine 10 while in normal operation. These controls may include a joystick 38 and a control panel 40 that can be easily accessed by an operator through the operator cabin 18. The joystick 38 controls a plurality of functions associated with the machine 10, and supports the control switch 34. Therefore, the operator may access the joystick 38 to trigger the control switch 34. Although, in the present disclosure, the control switch 34 is shown to be supported on the joystick 38, it may be noted that the control switch 34 may be supported and positioned anywhere in the operator cabin 18. It may be envisioned that position of the control switch 34 does not affect the novelty of the present disclosure.

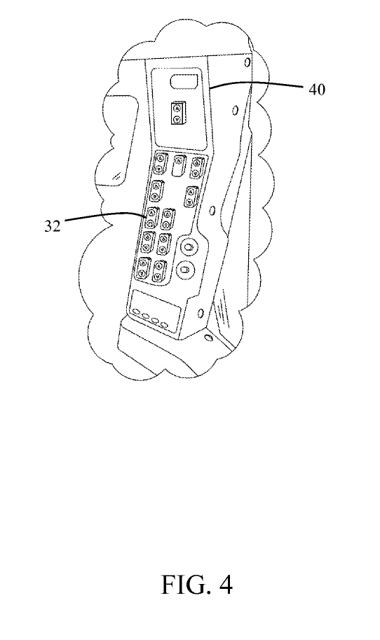

Referring to FIG. 4, there is shown an enlarged view of the control panel 40 of the machine 10. The control panel 40 includes a number of trigger switches that control various operations of the machine 10. In a preferred embodiment, the control panel 40 includes the mode switch 32 of the automatic differential control system 24 that may be accessed by the operator to activate the automatic differential control system 24. Although, in the present disclosure, the mode switch 32 is shown to be supported on the control panel 40, it may be noted that the mode switch 32 may be supported and positioned anywhere in the operator cabin 18. It may be envisioned that position of the mode switch 32 does not affect the novelty of the present disclosure.

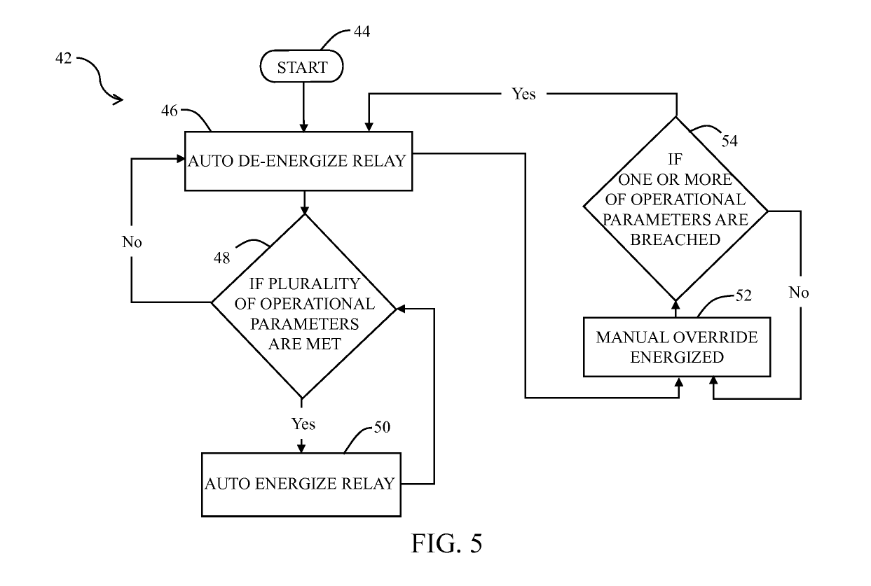

Referring to FIG. 5, there is shown a flow-chart that illustrates an exemplary method 42 to controllably lock and unlock the differential assembly 20 of the machine 10. The method 42 initiates at step 44.

At step 44, the automatic differential control system 24 is activated to selectively lock the differential assembly 20 by actuating the mode switch 32 to the automatic mode position. As the automatic differential control system 24 is activated, the method 42 then proceeds to step 46.

At step 46, the lock relay 28 is de-energized. De-energizing the lock relay 28 corresponds to de-energizing of the lock solenoid 26 and correspondingly deactivation of the differential lock 22. As is customarily known in the art, deactivation of the differential lock 22 corresponds to unlocking of the differential assembly 20. Therefore, the differential assembly 20 is initially unlocked as the automatic differential control system 24 is activated. The method 42 then proceeds to step 48.

At step 48, the controller 30 senses operational parameters of the machine 10 and compares it with predetermined limits If the operational parameters are met and are within predetermined limits, the method 42 proceeds to step 50. However, if the operational parameters are not met and breaches predetermined limits, the method 42 returns to step 46.

At step 50, the controller 30 energizes the lock relay 28. Energizing the lock relay 28 corresponds to energizing of the lock solenoid 26 and correspondingly activation of the differential lock 22. As is customarily known in the art, activation of the differential lock 22 corresponds to locking of the differential assembly 20. The method 42 then returns to step 48.

Furthermore, the method 42 may repeatedly perform steps 46, 48, and 50 until the control switch 34 is triggered to initiate manual override mode. To activate the manual override mode, an operator may trigger the control switch 34. As the control switch 34 is triggered, the automatic differential control system 24 is overridden and the method 42 proceeds to step 52.

At step 52, the lock relay 28 is energized and correspondingly the lock solenoid 26 is energized. As is commonly known, energizing the lock solenoid 26 corresponds to activation of the differential lock 22. This causes the differential assembly 20 to be locked. The method 42 then proceeds to step 54.

At the end step 54, the controller 30 again senses operational parameters of the machine 10. If one or more of the operational parameters breaches predetermined limits, the controller 30 de-energizes the lock relay 28 and correspondingly the lock solenoid 26, thereby deactivating the manual override mode, and returns to step 46. If none of the operational parameters breaches predetermined limits while the manual override mode is active, the method 42 returns to step 52. Thereby, the differential lock 22 is selectively activated and/or deactivated to lock and unlock the differential assembly 20.

### INDUSTRIAL APPLICABILITY

In operation, the machine 10 may travel from one place to another to perform various associated construction operations. As operation of the machine 10 is initiated, the automatic differential control system 24 of the machine 10 can be selectively activated using the mode switch 32. In other words, the differential lock 22 is initially in automatic mode of operation when the mode switch 32 is set to indicate the automatic mode position.

In the automatic mode of operation of the differential lock 22, the automatic differential control system 24 automatically locks and unlocks the differential assembly 20 based on the operational parameters of the machine 10. More specifically, the controller 30 may sense the operational parameters of the machine 10. Thereafter, the controller 30 may compare the operational parameters of the machine 10 with predetermined limits If the operational parameters are within those predetermined limits, the controller 30 energizes the lock relay 28 and correspondingly the lock solenoid 26 to activate the differential lock 22. More specifically, if the steering angle is below the lower steering threshold limit and the engine torque is above the upper torque threshold limit, while the gear range is also in a desired range, the controller 30 energizes the lock relay 28 and correspondingly the lock solenoid 26. Energizing the lock solenoid 26 activates the differential lock 22 and correspondingly locks the differential assembly 20. Also, if the operational parameters breach those pre-determined limits, the controller 30 de-energizes the lock relay 28. More specifically, if either the steering angle is above the upper steering threshold limit or the engine torque is below the lower torque threshold limit, or the gear range changes to an undesired range, the controller 30 de-energizes the lock relay 28 and correspondingly the lock solenoid 26. De-energizing the lock solenoid 26 deactivates the differential lock 22 and correspondingly unlocks the differential assembly 20. This process of automatic locking and unlocking the differential assembly 20 is repeated, until the manual override mode is manually activated by the operator using the control switch 34.

The manual override mode may be activated by triggering the control switch 34 in specific operating conditions of the machine 10. As the control switch 34 is triggered, the manual override mode is activated and the lock relay 28 is energized. Energizing the lock relay 28 corresponds to energizing of the lock solenoid 26 and correspondingly activation of the differential lock 22. This causes the differential assembly 20 to be locked by the differential lock 22. Since, the differential lock 22 in manual override mode is manually controlled for forward looking conditions, it is more reliable in operation. Therefore, the manual override mode may be actuated by triggering the control switch 34 in specific operating conditions of the machine 10 to allow engagement of differential lock 22 before the automatic differential control system 24 would otherwise command engagement.

Notably, while the manual override mode is operative, the automatic differential control system 24 is still active. In other words, while the manual override mode is operative, the controller 30 may continuously sense the operational parameters of the machine 10. Thereafter, the controller 30 may compare the operational parameters of the machine 10 with the predetermined limits If one of the operational parameters breaches predetermined limits, the controller 30 may de-energize the lock relay 28. More specifically, if either the steering angle is above the upper steering threshold limit or the engine torque is below the lower torque threshold limit, or the gear range is changed to an undesirable range, the controller 30 de-energizes the lock relay 28. Thereby, the manual override mode is deactivated. This may cause the differential assembly 20 to be automatically unlocked. Therefore, the differential assembly 20 will be automatically unlocked even if the operator forgets to manually unlock it. This avoids undue stresses on various components of the machine 10 during normal operation of the machine 10. This results in increased reliability of the machine 10 to lock and unlock the differential assembly 20 when needed for specific operating conditions.

It should be understood that the above description is intended for illustrative purposes only and is not intended to limit the scope of the present disclosure in any way. Those skilled in the art will appreciate that other aspects of the disclosure may be obtained from a study of the drawings, the disclosure, and the appended claim.

What is claimed is:

1. A method for controlling a differential assembly of a machine, the machine including an automatic differential control system, the differential assembly having at least one differential lock to selectively lock the differential assembly, the at least one differential lock adapted to operate in at least one of an automatic mode and a manual override mode, the method comprising:
activating the automatic differential control system to selectively lock the differential assembly;
overriding the automatic differential control system by activating the manual override mode, thereby locking the differential assembly manually, while keeping the automatic differential control system activated; and
deactivating the manual override mode by using the automatic differential control system based on one or more of a plurality of operational parameters, thereby unlocking the differential assembly.
